(19) United States
(12) Patent Application Publication
(10) Pub. No.: US 2022/0179112 A1
(43) Pub. Date: Jun. 9, 2022

(54) DETECTING AND MONITORING FORMATION FEATURES WITH AN OPTICAL FIBER

(71) Applicant: SAUDI ARABIAN OIL COMPANY, Dhahran (SA)

(72) Inventors: Mustafa N. AlAli, Moscow (RU); Timur Zharnikov, Moscow (RU); Thierry-Laurent D. Tonellot, Montferrier Sur Lez (FR); Ali Ameen Almomin, Dammam (SA); Marwan Charara, Moscow (RU)

(73) Assignees: SAUDI ARABIAN OIL COMPANY, Dhahran (SA); Aramco Innovations LLC, Moscow (RU)

(21) Appl. No.: 17/115,190

(22) Filed: Dec. 8, 2020

(51) Int. Cl. G01V 1/22; G01V 1/42; G01V 1/30; G01V 1/36

(52) U.S. Cl. CPC G01V 1/226; G01V 1/42; G01V 2210/51; G01V 1/362; G01V 1/303

(57) ABSTRACT

A system including a sonic source deployed in a first borehole and a fiber optic distributed sensor deployed in a second borehole, both boreholes extending from an earth surface into a formation. The optical fiber is configured to react along its length to incident sonic waves generated by the sonic source and propagating through the first borehole, through the formation, and through the second borehole. The system further includes an optical source to launch optical pulses into the fiber optic distributed sensor while the sonic waves are incident on the fiber optic distributed sensor. The system also includes a data acquisition system coupled to the fiber optic distributed sensor to detect temporal variations in coherent Rayleigh noise (CRN) generated in the fiber optic distributed sensor in response to the optical pulses and the incident sonic waves; and a computer system configured to receive data from the data acquisition system.

### BACKGROUND

Borehole sonic surveys are typically conducted in the oil and gas for the purpose of determining the compressional velocity and shear sonic velocity of the formation surrounding the borehole as a function of position along the borehole and direction of propagation. Consequently, conventional borehole sonic survey tools are usually optimized for determining the compressional velocity and shear sonic velocity. However, borehole sonic tools are sometimes conducted for a different purpose, namely imaging sonic reflectors located at a range of several feet to several tens of feet away from the borehole. These sonic reflectors may be lithological boundaries, pore fluid boundaries, and fractures and faults.

Although borehole sonic surveys intended to image sonic reflectors may be conducted with conventional borehole sonic survey tools, these tools are not optimized for making these surveys. In particular, they have limited sensor aperture and sensor spacing which may not be optimized for the task of imaging sonic reflectors located at distances of several tens of feet from away from the borehole. For this reason a device, and a method of use, optimized to conduct image sonic reflectors is a long felt need in the oil and gas industry.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a system including a sonic source deployed in a first borehole and a fiber optic distributed sensor deployed in a second borehole, both boreholes extending from an earth surface into a formation. The optical fiber is configured to react along its length to incident sonic waves generated by the sonic source and propagating through the first borehole, through the formation, and through the second borehole. The system further includes an optical source to launch optical pulses into the fiber optic distributed sensor while the sonic waves are incident on the fiber optic distributed sensor. The system also includes a data acquisition system coupled to the fiber optic distributed sensor to detect temporal variations in coherent Rayleigh noise (CRN) generated in the fiber optic distributed sensor in response to the optical pulses and the incident sonic waves; and a computer system configured to receive data from the data acquisition system.

In general, in one aspect, embodiments relate to deploying a sonic source in a first borehole extending from a surface into a formation, and deploying a fiber optic distributed sensor in a second borehole extending from an earth surface into a formation. The fiber optic distributed sensor configured to react along its length to incident sonic waves generated by the sonic source and propagating through the first borehole, through the formation, and through the second borehole. The method further includes launching, from an optical source, optical pulses into the fiber optic distributed sensor while the sonic waves are incident on the fiber optic distributed sensor, and acquiring data using an acquisition system coupled to the fiber optic distributed sensor to detect temporal variations in coherent Rayleigh noise generated in the fiber optic distributed sensor in response to the optical pulses and the incident sonic waves. Furthermore the method includes receiving data from the data acquisition system, wherein the received data is used by a non-transitory computer readable medium comprising instructions to perform an inversion of the received data to determine a sonic characteristic of the formation in the vicinity of the sonic source and the fiber optic distributed sensor.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows an example, in accordance with one or more embodiment.

FIG. 2 shows an example, in accordance with one or more embodiment.

FIG. 3 shows an example, in accordance with one or more embodiment.

FIG. 4 shows an example, in accordance with one or more embodiment.

FIG. 5 shows a flowchart, in accordance with one or more embodiments.

FIG. 6 shows a flowchart illustrating full waveform inversion, in accordance with one or more embodiments.

FIG. 7 shows a flowchart illustrating reverse time migration, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Embodiments disclosed herein relate to the high-resolution (several meters and less) deep penetration (several tens of feet and more) imaging of a formation structure and determining its quantitative characteristics. Such imaging and characterization may enable the discovery of bypassed oil (pinch-outs), help optimizing the production and better planning and constructing the well. Existing tools for formation imaging using sonic frequencies are based on traditional wireline tools. Such tools are designed with the primary purpose of measuring formation characteristics such as its elastic moduli, anisotropy, stress, etc. Therefore, the development of the tools specifically designed and optimized for the deep sonic formation measurements is desirable.

In particular, traditional wireline tools have a limited maximum source to sensor distance of typically approximately 15 feet, or less. In addition, traditional wireline tools have a limited sonic sensor array aperture, defined as the distance between the farthest from the source and the sensor closest to the source. Typically, the sonic sensor array aperture may be 6 feet, or less.

The maximum source receiver distance is important because it controls the relative arrival times of reflections from formation structures and wave modes propagating with the borehole. Frequently, the largest signal recorded in sonic logging it the Stoneley mode which propagates along the borehole with a velocity, V_{ST}, similar to that of the sonic speed in the borehole fluid. Sonic reflections from formation structures are usually significantly smaller than the Stoneley mode, and may be difficult to detect if they arrive at the same time as, or later than, the Stoneley mode. Consequently, it is highly desirable to have a sonic source to sonic sensor distance such that the sonic reflection of interest arrives at the sonic sensor before the Stoneley mode, when it is more easily detected. For example, for a sonic reflector parallel to the borehole the orthogonal distance of the reflector from the borehole, d, at which the sonic reflection and the Stoneley mode arrives coincidentally, may be given by:

$$d = \frac{L}{2} \sqrt{{( \frac{V}{{V}_{ST}} )}^{2} - 1} \qquad Equation ( 1 )$$

where L is the distance between the sonic source and the sonic sensor, and V is the sonic wave propagation speed in the formation. Clearly, d increases linearly with l, the sonic source to sonic sensor distance and thus a large value of l facilitates detecting sonic reflectors at great depths of penetration, d.

The sonic sensor array aperture may affect the quality of sonic survey measurement, and depth of penetration in two ways. Firstly, a larger aperture facilitates the separation, via signal processing, of sonic waves crossing the array at different speeds. One of ordinary skill in the art knows a number of methods for achieving such a separation of sonic waves crossing the array at different speeds. Secondly, a larger aperture increases the number of times a particular portion of a sonic reflector is sampled as a sonic survey tool is moved along the borehole near the reflector. This increased sampling, known to one of ordinary skill in the art as “fold” improves signal-to-noise ratio because the samples may be combined, or “stacked” to improve signal to noise ratio.

Unlike traditional wireline tools, a fiber optic distributed sensor may detect sonic waves impinging upon them at all points along their length. Such a fiber optic distributed sensor may extend from the earth's surface to the toe of a well, a distance frequently in excess of 10,000 feet, or 2 miles. Thus, the effective aperture of a fiber optic distributed sensor may greatly exceed that of the typical traditional wireline tool aperture of 6 feet, or less.

In general, borehole sonic surveys are performed by recording sonic waves using a single sensor or an array of sensors located in a borehole logging tool deployed in a borehole that extends from the earth surface into a sub-surface formation. Depending on the particular application, sonic waves may be generated by one or more seismic sources located in the borehole logging tool, in the borehole in which the sonic waves are detected, and/or in an adjacent borehole. A wide variety of sonic sources may be used to generate the sonic waves. For instance, common downhole sonic sources may include piezoelectric pulsers, orbital-, vertical and radial-vibrators, hammers, and sparkers, implosive canisters.

The sonic energy generated as a result of the sonic source may be recorded by any of a variety of types of sonic sensors, such as hydrophones, geophones, accelerometers, or a combination thereof. In typical downhole applications, these types of sensors are coupled to electrical components downhole which amplify, condition (e.g., band-pass) and digitize the electrical signals generated by the sensors in response to detection of a seismic event. The digitized signals may then be transmitted (e.g., via electrical wireline, mud pulse telemetry, optical fiber, etc.) to the surface where they are recorded. In other embodiments, they may be temporarily stored in a downhole storage device, such as a solid-state memory, and then later retrieved. In either configuration, the need for downhole electronics adds to the physical size, cost and complexity of the borehole logging tool. In addition, downhole electronics must be able to withstand, or be protected from, elevated temperatures and pressures of the downhole environment for extended periods of time.

These constraints, when combined with limitations on the amount of power that can be delivered downhole and the amount of data that can either be stored downhole or transmitted to the surface, have also restricted the number of sensors that may be used in a sonic borehole logging tool. Despite modern technological advances, recent sonic survey tools typically deploy little more than one hundred sensors, and twelve or fewer sonic sources.

The size constraint also is a serious limitation since the seismic tool is deployed in a confined location (i.e., in a borehole). For instance, current sonic borehole logging tools typically have a diameter of two or more inches. This size limits the manner in which the survey tool may be deployed since its relatively large diameter may preclude running the tool either with a drillstring or inside the production tubing (if one is installed) or in the annulus between the casing and the tubing or drillstring. As a result, either the drillstring or production tubing often must be removed from the borehole before the sonic logging tool may be introduced and the survey conducted. Since removal of tubing or drillstring is a time consuming and costly procedure, performing a survey in this manner is undesirable.

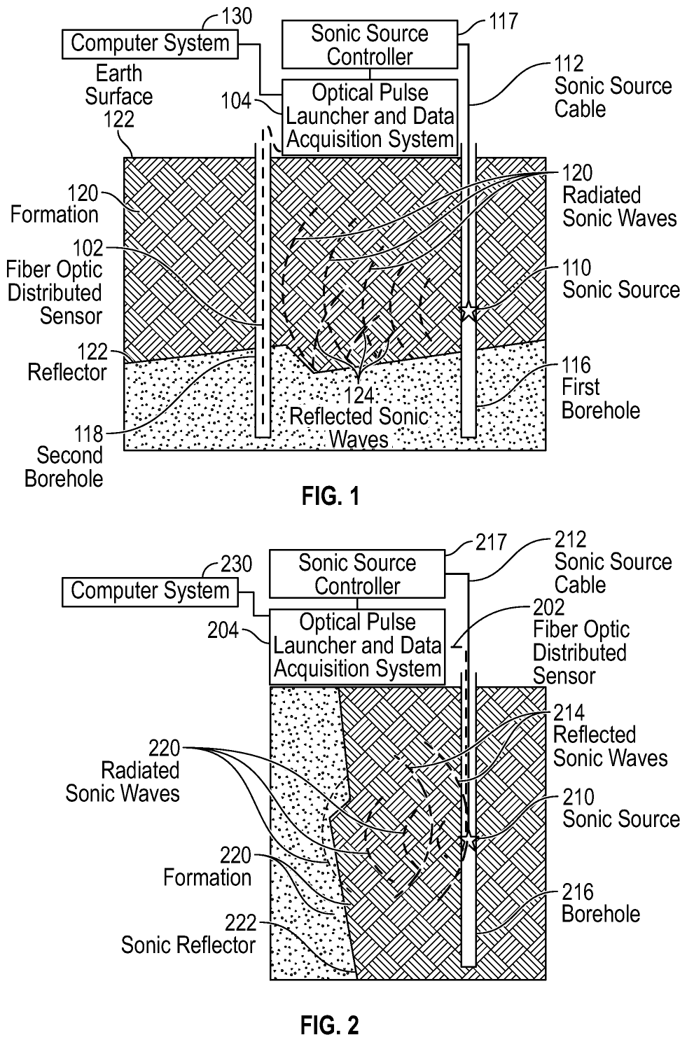

FIG. 1 shows one exemplary embodiment of a sonic source (110) deployed by means of a sonic source cable (112) in a first borehole (116), and a fiber optic distributed sensor (102) deployed in a second borehole (118). Both the first borehole and the second borehole traverse a formation (1.20) beneath the earth surface (114). On the earth surface (114) the sonic source cable (112) is attached to a sonic source controller (117). The sonic source controller (11.7) excites the sonic source (110) to emit radiated sonic waves (118) at times determined by the sonic source controller (117). The sonic source 10) may emit a monopole radiation pattern, or a dipole radiation pattern or a quadrupole radiation pattern, or a multipole radiation pattern from an azimuthal phased array. The sonic source controller (117) may further be connected to the optical pulse launcher and data acquisition system (104), in such a manner that the parameters of the sonic source (110) excitation including, without limitation, the excitation time, the excitation waveform, and the excitation radiation pattern may be recorded by the optical pulse launcher and data acquisition system (104).

In other embodiments, the sonic source (110) may be deployed on a drillstring and activated, in a controllable manner, at the desired time. In these embodiments, time-synchronization between the sonic source (100) activation times and the optical pulse launcher and data acquisition system (104) using wired-drillpipe telemetry, or using mud-pulse telemetry, or using electromagnetic telemetry, or through high-accuracy downhole clocks.

In further embodiments, the sonic source (110) may be the drill bit which generates sonic energy as a by-product during its normal drilling operation. In these embodiments, time-synchronization between the sonic waves emitted by the drill bit, and the optical pulse launcher and data acquisition system 104) may be achieved using wired-drillpipe telemetry, or using mud-pulse telemetry, or using electromagnetic telemetry, or through high-accuracy downhole clocks. Time-synchronization may further utilize a sonic sensor attached to the drill-string in the immediate vicinity of the drill bit. This sonic sensor may detect and record the radiated sonic waves in the immediate vicinity of their source.

In still further embodiments, the sonic source (110) may be an autonomous sonic source, free to move up and down the well under the forces of buoyancy and gravity, or self-propelled by an attached or integrated propulsion unit. In these embodiments, time-synchronization between the sonic waves emitted by the drill bit, and the optical pulse launcher and data acquisition system (104) may be achieved using high-accuracy downhole clocks connectively attached to the autonomous sonic source.

The radiated sonic waves (120) may propagate directly to the second borehole (118). In addition, the radiated sonic waves may interact with a sonic reflector (122) thereby generating reflected sonic waves (124), Both the radiated sonic waves (120) and the reflected sonic waves (124) may propagate to the second borehole (118) where they may impinge on the fiber optic distributed sensor (102).

In accordance with one or more embodiments, the fiber optic distributed sensor (102) may be attached to an optical pulse launcher and data acquisition system (104). The optical pulse launcher and data acquisition system (104) includes an optical source that generates an optical signal, such as an optical pulse, for interrogating the fiber optic distributed sensor (102), which is deployed in the second borehole (118). In some embodiments, the optical source may comprise a narrowband laser (e.g., a fiber distributed feedback laser) and a modulator that selects short pulses from the output of the laser. Optionally, an optical amplifier may be used to boost the peak power of the pulses. In some embodiments, this amplifier may be placed after the modulator. The amplifier may also be followed by a filter for filtering in the frequency domain (by means of a band-pass filter) and/or in the time domain (by means of a further modulator).

The pulses emitted from the optical source may be launched into the optical fiber distributed sensor through a directional coupler, which separates outgoing and returning signals and directs the latter to an optical receiver. The optical receiver may be integrated into the optical pulse launcher and data acquisition system (104), as shown, or may be a separate unit. The directional coupler may be in bulk optic form using a beam-splitter, or it may comprise a fiber-optic coupler, a circulator, or a fast switch (e.g. an electro-optic or acousto-optic switch). The backscattered optical signal returned from the fiber optic distributed sensor (102) in response to the interrogating optical pulses may be detected and converted into an electrical signal at the optical receiver. The optical pulse launcher and data acquisition system (104) may acquire this electrical signal.

In some embodiments, the optical pulse launcher and data acquisition system (104) analyzes the returning signals received to determine, the locations along the fiber optic distributed sensor (102), where the signal is changing in response to the impinging sonic wave. In addition, the optical pulse launcher and data acquisition system (104) may interpret this change in terms of sonic waves modulating the backscatter return of the fiber optic distributed sensor (102). Software code or instructions for performing the analysis and interpretation may be stored in a memory included in the optical pulse launcher and data acquisition system (104).

More specifically, the returning signal produced in response to the interrogating optical pulse is directed to the optical pulse launcher and data acquisition system (104). At any given time, T, corresponding to a particular distance along the fiber optic distributed sensor (102), the optical field arriving at the receiver is the vector sum of all the optical fields generated by all the optical scatterers within the length of the fiber optic distributed sensor (102), that was occupied by the launched optical pulse at time T/2. The relative phase of these optical scatterers, dependent on the laser wavelength and distribution of the optical scatterers, determines whether the signals from these optical scatterers sum to a large absolute value (constructive interference) or essentially cancel each other out (destructive interference).

When the radiated sonic waves (120), and the reflected sonic waves (124) impinging on, and couple to, the fiber optic distributed sensor (102), the impinging sonic waves (120, 124) strain the fiber optic distributed sensor (102). The strain on the fiber optic distributed sensor (102), changes the relative position between the scattering centers by simple elongation of the fiber. The strain also changes the local refractive index of the glass of the fiber optic distributed sensor (102). Both of these effects alter the relative phase of the light scattered from each scattering center. As a result, the interference signal in the disturbed portion of the fiber optic distributed sensor (102) is varied by modulation of the length of the fiber optic distributed sensor (102), since an interference signal that may have been constructive (i.e., the scattering from each center was roughly in-phase, their electric fields sum to a large value) is now destructive (i.e., the relative phase of the scattered signals from each reflector sum to a small electric field amplitude).

The optical pulse launcher and data acquisition system (104) may be connected to a computer system (130) which contains instructions for processing the acquired sonic waveform recordings. The illustrated computer (130) is intended to encompass any computing device such as a high performance computing (HPC) device, server, desktop computer, laptop, notebook computer, wireless data port, smart phone, personal data assistant (PDA), tablet computing device, one or more processors within these devices, or any other suitable processing device, including both physical or virtual instances (or both) of the computing device. Additionally, the computer (130) may include a computer that includes an input device, such as a keypad, keyboard, touch screen, or other device that can accept user information, and an output device that conveys information associated with the operation of the computer (130), including digital data, visual, or audio information (or a combination of information), or a GUI.

In accordance with one or more embodiment, the computer system (130) may be located at or near the first borehole (116) or the second borehole (118). Alternatively, the computer system (130) may be located remotely in a local, regional or central computing center. In some implementations, one or more components of the computer system (130) may be configured to operate within environments, including cloud-computing-based, local, global, or other environment (or a combination of environments).

FIG. 2 shows an exemplary embodiment, wherein the first borehole and the second borehole are collocated, and there is only a single borehole (216) in which both the sonic source (210) and the fiber optic distributed sensor (202) are deployed. In accordance with one or more embodiments, the sonic source cable (212) and the fiber optic distributed sensor (202) are integrated into a single cable providing both power and control signals to the sonic source (210) and also sensing the sonic waves impinging on it along its length. In one or more embodiments, the sonic source (210) may be attached to the bottom of the integrated cable. In other embodiments the sonic source (210) may be located at an intermediate location along the length of the integrated cable so the sonic waves may impinge upon the fiber optic distributed sensor both above and below the sonic source (210).

In accordance with one or more embodiments, the fiber optic distributed sensor (202) and the sonic source cable (212) may be deployed independently in the borehole (216). This independent deployments may allow the sonic source cable (212) and the attached sonic source (210) to be raised an lower within the borehole (216) independently from the fiber optic distributed sensor (202) which may remain stationary during the motion of the sonic source (210).

In accordance with one or more embodiments, the sonic source (210) illustrated in FIG. 2 may be excited by the sonic source controller (217) to emit radiated sonic waves (220). The sonic source (210) may emit a monopole radiation pattern, or a dipole radiation pattern or a quadrupole radiation pattern. Furthermore, the sonic source (110) may be a phased array source. The phased array source may comprise a plurality of elements, each of which may be activated at a controllable time. The phased array source may emit a multipole radiation pattern determined by the differences in the controllable activation time at which each of the plurality of elements are activated. The sonic source (210) may emit a radiation pattern comprising any combination of a monopole, a dipole, and a quadrupole radiation pattern. The sonic source controller (117) may further be connected to the optical pulse launcher and data acquisition system (204), in such a manner that the parameters of the sonic source (210) excitation including, without limitation, the excitation time, the excitation waveform, and the excitation radiation pattern may be recorded by the optical pulse launcher and data acquisition system (104). The radiated sonic waves (220) may then impinge on a sonic reflector (222) and thereby create reflected sonic waves (214). The sonic reflector may be, without limitation, a boundary between different types of rocks, a formation bed boundary, a boundary between different types of pore fluid, a boundary between different saturations of pore fluids, a fault, a fracture and a group of fractures, A portion of the reflected sonic waves (214) may then propagate back to the borehole (216) where they may impinge on the fiber optic distributed sensor (202).

When the radiated sonic waves (220), and the reflected sonic waves (224) impinging on, and couple to, and strain the fiber optic distributed sensor (202). The strain on the fiber optic distributed sensor (102), may change the relative phase of the returning optical signals which may be recorded b the optical pulse launcher and data acquisition system (204) as recorded data. This recorded data may then be communicated to a computer system (230).

In accordance with one or more embodiments, the computer system (230) may perform an inversion of the received data to determine a sonic characteristic of the formation (220) in the vicinity of the sonic source (210) and the fiber optic distributed sensor (202). This inversion may comprise full waveform inversion based, at least in part, on a datum within the data to determine a map of the sonic wave propagation speed in the vicinity of the sonic source (210) and the fiber optic distributed sensor (202). This inversion may comprise reverse time migration based, at least in part, on a datum within the data set to determine an image of one or more sonic reflectors (222) of sonic waves in the vicinity of the sonic source (210) and the fiber optic distributed sensor (202).

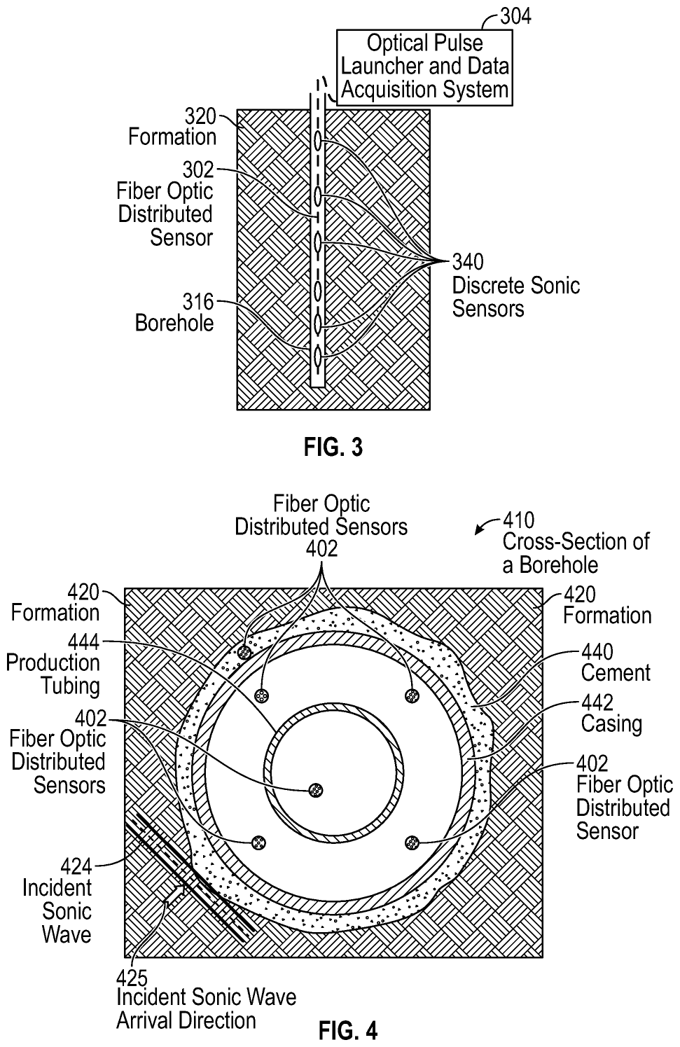

FIG. 3 shows the fiber optic distributed sensor (302) augmented with one or more discrete sonic sensors (340) located at points along the length of the fiber optic distributed sensor (302) and deployed in a borehole (316). In accordance with one or more embodiments a plurality of discrete sonic sensors (340) may be located at regular intervals along the length of the fiber optic distributed sensor (302), or the plurality of discrete sonic sensors (340) may be located at irregular intervals along the length of the fiber optic distributed sensor (302). The fiber optic distributed sensor (302) and the discrete sonic sensors (340) may all be configured so that they may all communicate data to the optical pulse launcher and data acquisition system (304).

In accordance with one or more embodiments, the discrete sonic sensors (340) may be hydrophones (which measure pressure fluctuations), or geophones (which measure particle velocity), or accelerometers (which measure particle acceleration), and may be discrete optical sensors. Hydrophones may use piezoelectric materials, or magnetostrictive materials which emit an electrical signal in response to an applied pressure. Geophones typically comprise a spring-mounted wire coil moving within the field of a permanent magnet. Accelerometers may also be based on a spring-mounted moving coil design, or may piezo-restrictive, or piezo-capacitive designs. In accordance with other embodiments, the discrete optical sensors (340) may utilize fiber Bragg gratings, or may utilize a Fabry-Péyrot interferometry principle. Alternatively, the discrete optical sensors (340) may be formed by coiling a portion of the fiber optic cable into a compact helix. The compact helix may be wound around a tubular member.

FIG. 4 shows the cross-section of a borehole (410) penetrating a formation (420), in accordance with one or more embodiments. The small diameter of the fiber optic distributed sensor (402), e.g., ¼ inch or less, allows for deployment of the fiber optic distributed sensor (402) either inside or behind production tubing (444) or the drillstring (not shown), or cemented permanently outside the casing (442) in the cement (440), thus eliminating the need to either shut in the well and/or remove the production tubing (444) or a drillstring before conducting a sonic survey. Further, fiber optic cable which forms the downhole component for the fiber optic distributed sensor (102) system is relatively inexpensive and, due to its non-toxic nature, may be abandoned or left inactive in the borehole (410) after use. Thus, the disposable nature of the optical fiber makes it feasible to deployment of the fiber optic distributed sensor (444) outside casing and within the cement.

Furthermore, FIG. 4 shows a plurality of fiber optic distributed sensors (402) distributed at a plurality of radii and azimuths within the borehole (410), in accordance with one or more embodiments. The configuration shown in FIG. 4 may be used to determine the arrival direction (425) of an incident sonic wave (424). The fiber optic distributed sensor (402) positioned on a first side of the borehole (410) may sense the incident sonic wave (424) at an earlier time than a fiber optic distributed sensor (402) located on the opposite side of the borehole (410), if the first side of the borehole (410) is closer to the arriving sonic wave (424). Similarly, a first fiber optic distributed sensor (402) located close to the circumference of the borehole (410) may sense an incident sonic wave (424) earlier than a second fiber optic distributed sensor (402) located close to the axis of the borehole (410) if the first fiber optic sensor is located in the direction of arrival of the sonic wave (425).

Positioning a fiber optic distributed sensor (402) at a plurality of locations within the cross-section of a borehole (410) may be achieved by deploying a plurality of fiber optic distributed sensors (402) within the borehole (410). However, an alternative method for achieving a plurality of locations within the cross-section of a borehole (410) may be achieved by coiling the fiber optic distributed sensor (402) around the circumference of the borehole, or around a structure within the borehole (410), such as the casing (442), or the production tubing (444), in a helical manner. Although a helix may only pass through a cross-section of the borehole (410) at a single point it may occupy a plurality of different positions within the cross-section of the borehole (410) within a short axial distance. Thus, to a high-level of approximation it may produce a measurement equivalent to that produced by a plurality of fiber optic distributed sensors (402) at a plurality of locations within the cross-section of a borehole (410).

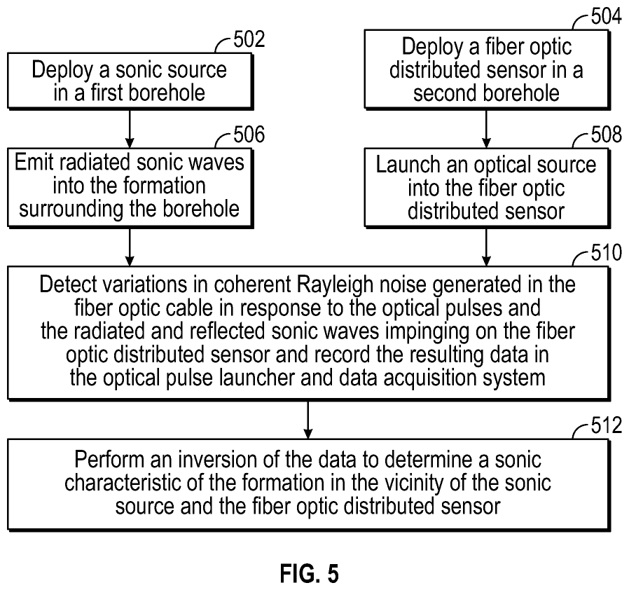

FIG. 5 shows a flowchart showing an exemplary embodiment of a sonic survey using a fiber optic distributed sensor, in accordance with one or more embodiments. In Block 502 a sonic source (110, 210) may be deployed in a first borehole (116, 216). In Block 504 a fiber optic distributed sensor (102, 202, 302, 402) may be deployed in a second borehole (218). In accordance with some embodiments, the first borehole (416) and the second borehole (418) may be the same borehole or neighboring boreholes. In Block 506 the sonic source (110, 210) may be excited by the optical pulse launcher and data acquisition system (104, 204) and emit radiated sonic waves (120, 220).

In Block 510 a portion of these sonic waves may impinge on the fiber optic distributed sensor (102, 202, 302), and the fiber optic distributed sensor (102, 202, 302) may detect variations in coherent Rayleigh noise generated in the fiber optic cable in response to the optical pulses and the radiated and reflected sonic waves impinging on the fiber optic distributed sensor. Further the optical pulse launcher and data acquisition system (104, 204) may record the resulting data.

In Block 510 an inversion of the data is performed to determine a sonic characteristic of the formation in the vicinity of the sonic source and the fiber optic distributed sensor. In accordance with one or more embodiment, performing the inversion may include performing full waveform inversion (FWI). In accordance with one or more embodiment, performing the inversion may include performing reverse time migration (RTM). In accordance with one or more embodiment, performing the inversion may include both FWI and RTM.

The speed of sonic wave propagation may vary with spatial position within a subterranean region of interest. Sonic wave propagation speed may be used to determine variations in rock properties, such as density, porosity or pore fluid composition. Sonic wave propagation speed may be used to simulation sonic wave propagation. Sonic wave propagation speed may be used to image bed boundaries, or a fracture or a group of fractures, or variation of pore fluid content within a region of interest.

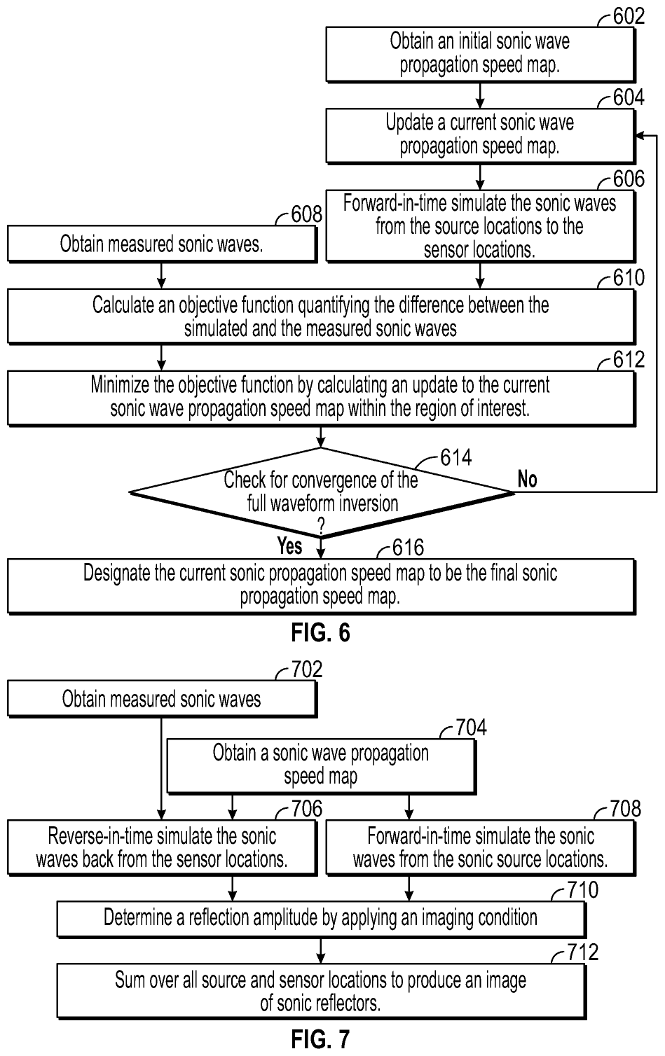

FIG. 6 shows a flowchart describing an exemplary embodiment of FWI. FWI is a method of inverting measured sonic data to generate a multidimensional map of the sonic propagation speed map of a region of interest. The multidimensional map may be three dimensional, or two dimensional, or one dimensional, depending upon the application and measurement distribution.

In Block 602, FWI obtains an initial estimate of the sonic wave propagation speed map for a region of interest surrounding the sonic source (110, 210) and the fiber optic distributed sensor (102, 202, 302, 402). The map may vary as a function of spatial position.

In Block 604 the initial sonic wave propagation speed map is first assigned to be the current sonic wave propagation speed map. Later in the flow, the current sonic wave propagation speed map will be updated iteratively as part of the inversion.

In Block 606 FWI uses the elastic wave equation, or a simplified version of the elastic wave equation, such as the acoustic wave equation or Helmholtz wave equation, to model the propagation of sonic waves within the subterranean region of interest and to simulate the sonic waves measured by the fiber optic distributed sensor and the discrete sonic sensors, based at least in part on the current sonic wave propagation speed map. In accordance with one or more embodiments, this modeling or sonic wave propagation and simulation of the sonic waves measured by the fiber optic distributed sensor and the discrete sonic sensors may be done by the computer system (130, 230).

In Block 608 measured sonic waves are obtained from the fiber optic distributed sensors, according to one or more embodiments.

In Block 610, the simulated sonic waves and the measured sonic waves may then be compared and a function, denoted an “objective function”, may be calculated quantifying the difference between the simulated and the measured sonic waves. In accordance with one or more embodiments the objective function may be the square of the difference between the measured sonic waves and the simulated sonic waves, summed over time samples, sonic sensors and sonic source excitations.

In Block 612, in accordance with one or more embodiments, the objective function may be minimized by calculating an update to current sonic wave propagation speed map within the region of interest.

In Block 614, the FWI may be checked for convergence. In accordance with one or more embodiment, the check for convergence may comprise evaluating the objective function and determining if the value of the objective function is below a preselected value, where the preselected value quantifies a satisfactory degree of similarity between the simulated sonic waves and the measured sonic waves. If the FWI has converged the current sonic wave propagation speed map may be designated as the final sonic wave propagation speed map, in Block 616, and the FWI process terminated. If the FWI has not converged, then the update to current sonic wave propagation speed map may be added to the current sonic wave propagation speed map to form a new current sonic wave propagation speed map in Block 604, and Blocks 606, 608, 610, 612 and 614 repeated iteratively.

FIG. 7 shows a flowchart illustrating an exemplary embodiment of Reverse Time Migration (RTM). RTM is a method of processing measured sonic reflection data to generate images of sonic reflectors within a region of interest. These sonic reflectors may be a boundary between two rock layers, or they may be a fault or a fracture or group of fractures within a rock layer, or they may be a boundary between the two different fluids within rock pores, or they may be a boundary between a fluid layer and a rock layer. Strong sonic reflection are generated where a large sonic impedance contrast exists between the medium on different sides of a boundary. RTM may be implemented using the computer system (130, 230).

In Block 702, in accordance with one or more embodiments, RTM obtains measured sonic waves. The measured sonic waves may be obtained from the fiber optic distributed sensor (102, 202, 302, 402), and may be obtained from the discrete sonic sensors.

In Block 704, RTM may obtain, in accordance with one or more embodiments, a sonic wave propagation speed map. This sonic wave propagation speed map may be obtained by performing FWI, or from a plurality of other methods familiar to one of ordinary skill in the art.

In Block 706, in accordance with one or more embodiments, RTM may use the elastic wave equation, or a simplified version of the elastic wave equation such as the sonic wave equation or Helmholtz wave equation to simulate the propagation of sonic waves from the fiber optic distributed sensor (102, 202, 302, 402) and the discrete sonic sensors (340) locations backwards-in-time, or in “reverse time”, into the formation (120, 220, 320) surrounding the sonic sensors.

Furthermore, in Block 708 in accordance with one or more embodiments, RTM uses the elastic wave equation, or a simplified version of the elastic wave equation, to simulate the propagation of sonic waves forward in time from the sonic source (110, 210) locations into the formation (120, 220, 320).

In Block 710, in accordance with one or more embodiments, RTM may use an imaging condition that employs the principle that the backward-in-time simulated sonic waves from the fiber optic distributed sensor (102, 202, 302, 402) and the discrete sonic sensors (340), and the forward-in-time simulated waves from the sonic source (110, 210) are collocated in the formation only at a spatial location where the forward-in-time propagating waves generated the reflected sonic waves. This principle of collocation may be implemented approximately as a zero-lag cross-correlation, or as a convolution combined with as an illumination compensation step, or as a deconvolution. Jones, “Tutorial: migration imaging conditions”, First Break, Vol. 32, pp 45-55, December 2014, provides further information and examples of imaging conditions.

Finally, in Block 712, in accordance with one or more embodiments, the reflection amplitude value determined by the imaging condition may be summed over all source, and all sensor locations to produce a RTM image of sonic reflectors of sonic waves in the vicinity of the sonic source (110, 210) and the fiber optic distributed sensor (102, 202, 302, 402).

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed:

1. A system, comprising:
a sonic source deployed in a first borehole extending from a surface into a formation;
a fiber optic distributed sensor deployed in a second borehole extending from an earth surface into a formation, the optical fiber configured to react along its length to incident sonic waves generated by the sonic source and propagating through the first borehole, through the formation, and through the second borehole;
an optical source to launch optical pulses into the fiber optic distributed sensor while the sonic waves are incident on the fiber optic distributed sensor;
a data acquisition system coupled to the fiber optic distributed sensor to detect temporal variations in coherent Rayleigh noise (CRN) generated in the fiber optic distributed sensor in response to the optical pulses and the incident sonic waves; and
a computer system configured to receive data from the data acquisition system, the computer system comprising a non-transitory computer readable medium with instructions to perform an inversion of the received data to determine a sonic characteristic of the formation in the vicinity of the sonic source and the fiber optic distributed sensor.

2. The system of claim 1, wherein:
the instructions to perform an inversion of the data set determining a sonic characteristic of the formation in the vicinity of the sonic source and the fiber optic distributed sensor comprise instructions to perform full waveform inversion based, at least in part, on a datum within the data to determine a map of the sonic wave propagation speed in the vicinity of the sonic source and the fiber optic distributed sensor.

3. The system of claim 1, wherein:
the instructions to perform an inversion of the data set determining a sonic characteristic of the formation in the vicinity of the sonic source and the fiber optic distributed sensor comprise instructions to perform reverse time migration based, at least in part, on a datum within the data set to determine an image of one or more sonic reflectors of sonic waves in the vicinity of the sonic source and the fiber optic distributed sensor.

4. The system of claim 1, wherein the first borehole and the second borehole are coincident in space.

5. The system of claim 1, wherein the sonic source is attached to the fiber optic distributed sensor.

6. The system of claim 1, further comprising:
one or more discrete sonic sensors distributed at intervals along the fiber optic distributed sensor.

7. The system of claim 6, wherein the one or more discrete sonic sensors are chosen from the group consisting of a piezoelectric hydrophone, and a discrete optical sensor.

8. The system of claim 7, wherein the discrete optical sensors are chosen from the group consisting of a fiber Bragg grating, a coiled fiber sensor, a fiber optic pressure sensor, and a fiber optic hydrophone.

9. The system of claim 1, wherein the sonic source is configured to emit a radiation pattern selected from the group consisting of a monopole radiation pattern, a dipole radiation pattern, a quadrupole radiation pattern, and a controllable multipole radiation pattern.

10. The system of claim 1, wherein the sonic source is selected from the group consisting of a piezoelectric source connected to a sonic source cable, a magnetostrictive source connected to a sonic source cable, a piezoelectric source connected to a drillstring, a magnetostrictive source connected to a drillstring, an autonomous sonic source free to move up and down the well under the forces of buoyancy and gravity, and an autonomous sonic source self-propelled by an attached or integrated propulsion unit.

11. The system of claim 1, wherein the fiber optic distributed sensor disposed in the second borehole extending from an earth surface into a formation, further comprises:
a plurality of fiber optic distributed sensor disposed in the second borehole extending from the earth surface into a formation at a plurality of locations within the cross-sectional area of the borehole.

12. A method, comprising:
deploying a sonic source in a first borehole extending from a surface into a formation;
deploying a fiber optic distributed sensor in a second borehole extending from an earth surface into a formation, the fiber optic distributed sensor configured to react along its length to incident sonic waves generated by the sonic source and propagating through the first borehole, through the formation, and through the second borehole;
launching, from an optical source, optical pulses into the fiber optic distributed sensor while the sonic waves are incident on the fiber optic distributed sensor;
acquiring data using an acquisition system coupled to the fiber optic distributed sensor to detect temporal variations in coherent Rayleigh noise generated in the fiber optic distributed sensor in response to the optical pulses and the incident sonic waves; and
receiving data from the data acquisition system, wherein the received data is used by a non-transitory computer readable medium comprising instructions to perform an inversion of the received data to determine a sonic characteristic of the formation in the vicinity of the sonic source and the fiber optic distributed sensor.

13. The method of claim 12, wherein:
the performing an inversion of the data set to determine a sonic characteristic of the formation in the vicinity of the sonic source and the fiber optic distributed sensor, comprise performing full waveform inversion based, at least in part, on a datum within the data set to determine a map of the sonic wave propagation speed in the vicinity of the sonic source and the fiber optic distributed sensor.

14. The method of claim 12, wherein:
the performing an inversion of the data set to determine a sonic characteristic of the formation in the vicinity of the sonic source and the fiber optic distributed sensor, comprise performing reverse time migration based, at least in part, on a datum within the data to determine an image of one or more sonic reflectors of sonic waves in the vicinity of the sonic source and the fiber optic distributed sensor.

15. The method of claim 12, wherein the first borehole and the second borehole are coincident in space.

16. The method of claim 12, wherein the sonic source is attached to the fiber optic distributed sensor.

17. The method of claim 12, wherein deploying, a fiber optic distributed sensor further comprises:
deploying one or more discrete sonic sensors distributed at intervals along the fiber optic distributed sensor.

18. The method of claim 17, wherein the one or more discrete sonic sensors are chosen from the group consisting of a piezoelectric hydrophone, a fiber Bragg grating, a coiled fiber sensor, a fiber optic pressure sensor, and a fiber optic hydrophone.

19. The method of claim 12, wherein the sonic source is configured to emit a radiation pattern selected from the group consisting of a monopole radiation pattern, a dipole radiation pattern, and a quadrupole radiation pattern.

20. The method of claim 12, wherein deploying the fiber optic distributed sensor in the second borehole extending from an earth surface into a formation, further comprises:
deploying, a plurality of fiber optic distributed sensors disposed in the second borehole extending from the earth surface into a formation at a plurality of locations within the cross-sectional area of the borehole.
